(19) United States
(12) Patent Application Publication
(10) Pub. No.: US 2018/0203875 A1
(43) Pub. Date: Jul. 19, 2018

(54) METHOD FOR EXTENDING AND SHRINKING VOLUME FOR DISTRIBUTED FILE SYSTEM BASED ON TORUS NETWORK AND APPARATUS USING THE SAME

(71) Applicant: ELECTRONICS AND TELECOMMUNICATIONS RESEARCH INSTITUTE, Daejeon (KR)

(72) Inventors: Joon-Young PARK, Daejeon (KR); Young-Kyun KIM, Daejeon (KR); Young-Chang KIM, Daejeon (KR); Hong-Yeon KIM, Daejeon (KR); Jeong-Sook PARK, Daejeon (KR)

(73) Assignee: ELECTRONICS AND TELECOMMUNICATIONS RESEARCH INSTITUTE, Daejeon (KR)

(21) Appl. No.: 15/661,961

(22) Filed: Jul. 27, 2017

(30) Foreign Application Priority Data
Jan. 18, 2017 (KR) 10-2017-0008513

(51) Int. Cl. G06F 17/30; H04L 29/08

(52) U.S. Cl. CPC G06F 17/30203; H04L 67/06; H04L 67/1097; G06F 17/30106

(57) ABSTRACT

Disclosed herein are a method for extending and shrinking a volume of a distributed file system based on a torus network and an apparatus for the same. The method for extending a volume includes searching for a volume neighboring a target volume, the extension of which is requested; determining a direction in which a data server is to be added in consideration of whether the neighboring volume is to be extended; searching for multiple candidate data servers in the direction in which a data server is to be added based on the target volume; and adding any one of the multiple candidate data servers to the target volume in consideration of at least one of a server state and a network communication cost.

### CROSS REFERENCE TO RELATED APPLICATION

This application claims the benefit of Korean Patent Application No. 10-2017-0008513, filed Jan. 18, 2017, which is hereby incorporated by reference in its entirety into this application.

### BACKGROUND OF THE INVENTION

### 1. Technical Field

The present invention relates generally to technology for resizing a volume of a large-scale distributed file system based on a torus network, and more particularly to technology for extending or shrinking a volume by adding or removing the most suitable data server to or from the volume in a distributed file system in order to improve the performance of individual volumes and to reduce the amount of power consumed by the entire system.

### 2. Description of the Related Art

In a large-scale distributed file system using a torus network, a great number of volumes compete for data server resources. In order to satisfy the performance required by individual volumes, it is essential to optimally allocate data servers to the volumes. Here, an administrator of the distributed file system must provide a storage service using minimal resources without performance degradation by increasing or decreasing the size of volumes, that is, by additionally allocating a data server to a volume or by removing a data server, already allocated to a volume, from the volume.

For example, when the number of clients that access a certain volume rapidly increases, the load on data servers allocated to the volume rapidly increases. Here, if a suitable data server is not additionally allocated to the volume, the clients connected to the corresponding volume suffer from significant performance degradation. Accordingly, in order to prevent such performance degradation in a large-scale distributed file system, it is necessary to extend or shrink a volume through the optimal allocation of data servers.

However, in a large-scale distributed file system using a torus network, if a data server is allocated to a volume without consideration of the torus network, the desired effect may not be achieved. The torus network may be constructed at low cost compared to a commonly used FAT tree, but the network cost between data servers connected to the torus network increases with the number of hops. Therefore, when extending a volume, it is necessary to consider not only the performance of individual servers but also the network cost incurred by the torus network. This is also necessary when shrinking a volume. Only if a data server allocated to a volume is removed in a manner that takes into consideration the network cost of the torus network is it possible to reduce the network cost between the remaining data servers occupying the shrunk volume.

Also, when extending or shrinking a volume, it is necessary to consider the states of volumes adjacent thereto. If two volumes are individually extended without giving consideration to volumes adjacent thereto, the direction in which one volume is extended and the direction in which another volume is extended may face each other, which may cause the two volumes to overlap. As the result, clients that access the two volumes may suffer from performance degradation.

Meanwhile, with the increase in the size of a distributed file system, power consumption also greatly increases. Accordingly, technology for reducing the amount of power consumed by the large-scale storage system becomes more important. However, if rarely accessed data servers are indiscriminately set to enter a sleep mode in order to reduce power consumption, a data server that can be frequently used in the near future must be woken up whenever it is used, which may cause serious performance degradation. Therefore, when extending or shrinking a volume, it is necessary to appropriately change the sleep mode of neighboring data servers in order to reduce power consumption. In connection with this, Korean Patent Application Publication No. 10-2016-0121380 (published on Oct. 19, 2016) discloses a technology related to “Distributed file system using torus network and method for configuring and operating distributed file system using torus network.”

### SUMMARY OF THE INVENTION

An object of the present invention is to provide a method for effectively extending and shrinking a volume in a distributed file system based on a torus network in order to construct large-scale storage.

Another object of the present invention is to provide technology for resizing a volume, which may minimize the cost of network communication between data servers allocated to a volume in consideration of the characteristics of a torus network.

A further object of the present invention is to prevent performance degradation that may arise from the overlap of volumes when resizing volumes of a distributed file system.

Yet another object of the present invention is to provide technology for reducing the amount of power consumed by the entire system when resizing a volume of a distributed file system.

In order to accomplish the above objects, a method for extending a volume of a distributed file system according to the present invention includes searching for a neighboring volume of an extension target volume, extension of which is requested depending on a number of requests for input/output of files stored therein from clients, in a distributed file system; determining a direction in which a data server is to be added to the extension target volume in consideration of whether the neighboring volume is to be extended; searching for multiple addition candidate data servers, from which a distance to the extension target volume is equal to or less than a preset search value in the direction in which a data server is to be added; and adding a data server to the extension target volume, the data server being selected from among the multiple addition candidate data servers in consideration of at least one of a server state of each of the multiple addition candidate data servers and a resulting network communication cost estimated when each of the multiple addition candidate data servers is added to the extension target volume.

Here, adding the data server may include selecting a single primary candidate data server that has gained a highest amount of points based on the server state and the resulting network communication cost from among the multiple addition candidate data servers; determining whether at least one secondary candidate data server, points of which are equal to or greater than a preset number of reference points, is present among the multiple addition candidate data servers; and when it is determined that the at least one secondary candidate data server is present, performing an additional allocation simulation for each of the primary candidate data server and the at least one secondary candidate data server, and selecting any one of the primary candidate data server and the at least one secondary candidate data server as the data server to be added depending on a result of the additional allocation simulation.

Here, selecting any one of the primary candidate data server and the at least one secondary candidate data server may be configured to select the data server to be added in consideration of a data server to be additionally added by each of the primary candidate data server and the at least one secondary candidate data server when the additional allocation simulation is performed.

Here, the additional allocation simulation may be configured to generate a virtual extended volume by adding any one of the primary candidate data server and the at least one secondary candidate data server to the extension target volume and to search for the data server to be additionally added by performing extension after recognizing the virtual extended volume as the extension target volume.

Here, the server state may include at least one of CPU utilization, memory utilization, and network utilization, and the resulting network communication cost may be a cost of communication between data servers, which increases with a number of hops based on a torus network corresponding to the distributed file system.

Here, selecting the single primary candidate data server may be configured to give more points as at least one of the CPU utilization, the memory utilization, the network utilization, and the resulting network communication cost is lower.

Here, selecting any one of the primary candidate data server and the at least one secondary candidate data server may be configured to perform the additional allocation simulation repeatedly as many times as a preset simulation number.

Here, the method may further include cancelling sleep modes of multiple data servers for further extension, from which a distance to an extended volume is equal to or less than a preset wakeup value, the extended volume being the extension target volume, extended by adding the data server thereto.

Here, determining the direction in which a data server is to be added may be configured such that a direction from the extension target volume to the neighboring volume is excluded from the direction in which a data server is to be added when the neighboring volume is expected to be extended.

Here, searching for the neighboring volume may be configured to search for a volume that includes a data server from which a distance to the extension target volume is equal to or less than a preset adjacency value as the neighboring volume.

Also, a method for shrinking a volume of a distributed file system according to an embodiment of the present invention includes searching for a neighboring volume of a shrinkage target volume, shrinkage of which is requested depending on a number of requests for input/output of files stored therein from clients, in a distributed file system; selecting multiple removal candidate data servers in the shrinkage target volume in consideration of whether the neighboring volume is to be extended; and removing a data server from the shrinkage target volume, the data server being selected from among the multiple removal candidate data servers in consideration of at least one of a server state of each of the multiple removal candidate data servers and a resulting network communication cost estimated when each of the multiple removal candidate data servers is removed from the shrinkage target volume.

Here, removing the data server may include giving points to each of the multiple removal candidate data servers based on the server state and the resulting network communication cost; and among the multiple removal candidate data servers, selecting a data server that has gained a highest amount of points as the data server to be removed.

Here, the server state may include at least one of CPU utilization, memory utilization, and network utilization, and the resulting network communication cost may be a cost of communication between data servers, which increases with a number of hops based on a torus network corresponding to the distributed file system.

Here, giving the points may be configured to give more points as at least one of the CPU utilization and the network utilization is higher, and to give more points as at least one of the memory utilization and the resulting network communication cost is lower.

Here, the method may further include determining whether a neighboring volume expected to be shrunk is present, the neighboring volume being adjacent to the shrinking target volume; and when it is determined that the neighboring volume expected to be shrunk is present, excluding a data server from which a distance to the neighboring volume expected to be shrunk is equal to or less than a preset reference value, among multiple data servers included in the shrinkage target volume, from the multiple removal candidate data servers.

Here, the method may further include setting multiple sleep-mode target data servers, from which a distance to a shrunk volume is equal to a preset sleep value, to enter a sleep mode, the shrunk volume being the shrinkage target volume, shrunk by removing the data server therefrom.

Here, setting the multiple sleep-mode target data servers to enter a sleep mode may include predicting whether the shrunk volume is to be further shrunk; and when the shrunk volume is predicted to be further shrunk, setting more data servers to enter a sleep mode by decreasing the sleep value.

Here, selecting the multiple removal candidate data servers may be configured such that, among multiple data servers included in the shrinkage target volume, a data server capable of being included in the neighboring volume or a data server located in a direction toward the neighboring volume is selected as the multiple removal candidate data servers when the neighboring volume is expected to be extended, and such that the multiple data servers included in the shrinkage target volume are selected as the multiple removal candidate data servers when the neighboring volume is not expected to be extended.

Here, searching for the neighboring volume may be configured to search for a volume that includes a data server from which a distance to the shrinkage target volume is equal to or less than a preset adjacency value as the neighboring volume.

Also, an apparatus for resizing a volume of a distributed file system according to an embodiment of the present invention includes a search unit for searching for a first neighboring volume that is adjacent to an extension target volume, extension of which is requested, and searching for a second neighboring volume that is adjacent to a shrinkage target volume, shrinkage of which is requested, in a distributed file system, the extension and the shrinkage being requested depending on a number of requests for input/output of files stored in the volume from clients; a selection unit for selecting multiple addition candidate data servers, from which a distance to the extension target volume is equal to or less than a preset search value in a direction in which a data server is to be added, in consideration of whether the first neighboring volume is to be extended, and selecting multiple removal candidate data servers in the shrinkage target volume in consideration of whether the second neighboring volume is to be extended; and a control unit for adding any one of the multiple addition candidate data servers to the extension target volume in consideration of at least one of a server state of each of the multiple addition candidate data servers and a resulting network communicate cost estimated when each of the multiple addition candidate data servers is added to the extension target volume, and removing any one of the multiple removal candidate data servers from the shrinkage target volume in consideration of at least one of a server state of each of the multiple removal candidate data servers and a resulting network communication cost estimated when each of the multiple removal candidate data servers is removed from the shrinkage target volume.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart that shows a method for extending a volume of a distributed file system according to an embodiment of the present invention;

FIG. 2 is a view that schematically shows the process of extending a volume according to the method for extending a volume, illustrated in FIG. 1;

FIG. 3 is a view that schematically shows an additional allocation simulation process according to the method for extending a volume, illustrated in FIG. 1;

FIG. 4 is a flowchart that shows the process of cancelling a sleep mode in preparation for subsequent extension of a volume in the method for extending a volume according to an embodiment of the present invention;

FIG. 5 is a view that schematically shows the process of cancelling a sleep mode, illustrated in FIG. 4;

FIG. 6 is a flowchart that shows a method for shrinking a volume of a distributed file system according to an embodiment of the present invention;

FIG. 7 is a view that schematically shows the process of shrinking a volume according to the method for shrinking a volume, illustrated in FIG. 6;

FIG. 8 is a flowchart that shows the process of performing a power-saving function after shrinking a volume in the method for shrinking a volume according to an embodiment of the present invention;

FIG. 9 is a view that schematically shows the process of performing a power-saving function, illustrated in FIG. 8; and

FIG. 10 is a block diagram that shows an apparatus for resizing a volume of a distributed file system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

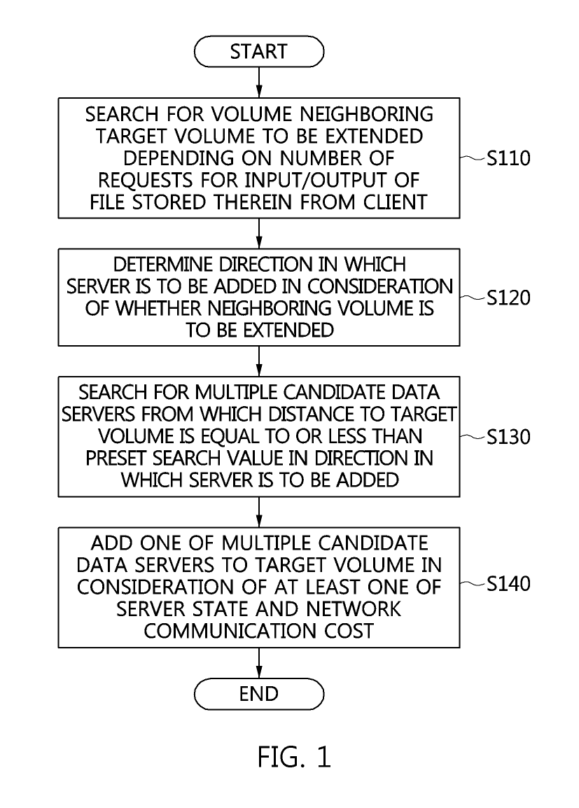

FIG. 1 is a flowchart that shows a method for extending a volume of a distributed file system according to an embodiment of the present invention.

Referring to FIG. 1, in the method for extending a volume of a distributed file system according to an embodiment of the present invention, for a target volume, the extension of which is requested depending on the number of requests for input/output of files stored therein from clients, in a distributed file system, a volume neighboring the target volume is searched for at step S110.

For example, the target volume to be extended may be a volume that has provided a storage service using one or more data servers since the outset but is predicted to be in a state in which the number of requests for data stored therein rapidly increases with the rapid increase in the number of clients. Accordingly, the target volume to be extended may be selected based on information about whether the number of clients is increasing or whether the number of requests for input/output of files stored in the volume is increasing.

Here, a volume that includes a data server from which the distance to the target volume is equal to or less than a preset adjacency value may be searched for, and the found volume may be regarded as a neighboring volume. For example, based on a torus network, data servers as many hops as the preset adjacency value away from the target volume are searched for, and a volume including at least one of the found data servers may become a neighboring volume.

Here, the preset adjacency value may be set by a system administrator, and may be freely modified depending on how a system is managed.

Here, multiple neighboring volumes may be present according to the distributed file system.

Also, in the method for extending a volume of a distributed file system according to an embodiment of the present invention, a direction in which a data server is to be added to the target volume is determined at step S120 in consideration of whether a neighboring volume is to be extended.

That is, the direction in which a data server is to be added may be determined in consideration of whether a neighboring volume is expected to be extended because of frequent access thereto by clients.

Here, when a neighboring volume is expected to be extended, the direction from the target volume to the neighboring volume may be excluded from the direction in which a data server is to be added.

For example, assume that the neighboring volume expected to be extended is located above the target volume in the direction of the y-axis in a 2-dimensional coordinate system. Here, the upward direction from the position of the target volume may be excluded from the direction in which a data server is to be added.

Here, the neighboring volume expected to be extended tends to be continuously extended. Accordingly, if the target volume adds a data server thereto in the direction toward the position of the neighboring volume, it is probable that the target volume and the neighboring volume will overlap due to the addition of the same data server. In order to decrease the probability of such overlap, the direction toward the position of the neighboring volume expected to be extended is not set as the direction in which a data server is to be added, whereby a data server is prevented from being added in the direction toward the position of the neighboring volume that is expected to be extended.

Also, in the method for extending a volume of a distributed file system according to an embodiment of the present invention, multiple addition candidate data servers, from which the distance to the target volume is equal to or less than a preset search value, are searched for in the direction in which a data server is to be added at step S130.

For example, if the preset search value is 2, multiple data servers two or fewer hops away from the target volume are searched for, and the found data servers may be regarded as multiple addition candidate data servers. Here, if a certain direction is excluded from the direction in which a data server is to be added, data servers located in the corresponding direction may not be searched for.

Here, the preset search value may be set by the system administrator.

Also, in the method for extending a volume of a distributed file system according to an embodiment of the present invention, any one of the multiple addition candidate data servers is added to the target volume at step S140 in consideration of at least one of a server state of each of the multiple addition candidate data servers and a resulting network communication cost estimated when each of the multiple addition candidate data servers is added to the target volume.

That is, among the multiple addition candidate data servers, the data server that is most suitable in consideration of the server state and the resulting network communication cost may be selected as the data server to be added to the target volume.

Here, the server state includes at least one of CPU utilization, memory utilization, and network utilization, and the network communication cost may be the cost of communication between data servers, which increases with the number of hops therebetween based on a torus network, which is a distributed file system.

Here, in the distributed file system, the network communication cost is very important because data servers continuously send and receive data therebetween in order to realize fault tolerance.

Here, among the multiple addition candidate data servers, any one primary candidate data server that has gained the highest amount of points based on the server state and the network communication cost may be selected.

Here, as the CPU utilization, the memory utilization, the network utilization, and the network communication cost are lower, more points may be given. That is, a data server of which the CPU utilization, the memory utilization, the network utilization, and the network communication cost are lower may be more advantageously added for extension.

Here, among the multiple addition candidate data servers, whether at least one secondary candidate data server that has gained points equal to or greater than a preset number of reference points is present may be determined.

Here, the preset number of reference points may be a certain percentage of the full points, awarded based on the server state and the network communication costs, or may be a certain percentage of the points of the primary candidate data server.

Here, if at least one secondary candidate data server is present, an additional allocation simulation is performed for each of the primary candidate data server and the at least one secondary candidate data server, and any one of the primary candidate data server and the at least one secondary candidate data server may be selected as the data server to be added depending on the result of the additional allocation simulation.

Here, the data server to be added may be selected in consideration of data servers expected to be additionally added by each of the primary candidate data server and the at least one secondary candidate data server when the additional allocation simulation is performed.

Specifically, the additional allocation simulation is configured to generate a virtual extended volume by adding any one of the primary candidate data server and the at least one secondary candidate data server to the target volume and to search for data servers expected to be additionally added when performing extension after recognizing the virtual extended server as the target volume to be extended.

That is, the additional allocation simulation may be a means for checking the states and network costs of data servers expected to be additionally allocated to the target volume when repeatedly performing the process of extending the target volume according to the present invention.

Here, the additional allocation simulation may be performed repeatedly as many times as a preset simulation number. For example, when the system administrator sets the value of ‘whatif’, corresponding to the preset simulation number, to 2, the additional allocation simulation may be performed twice for each of the primary candidate data server and the at least one secondary candidate data server.

By performing the additional allocation simulation as described above, whether the primary candidate data server that has gained the highest amount of points is most suitable as the data server to be added for the extension of the target volume may be verified.

That is, if there is a secondary candidate data server that has gained a relatively high amount of points, other than the primary candidate data server, the additional allocation simulation is also performed for the secondary candidate data server, and then the result may be compared with the result of the simulation performed for the primary candidate data server. Even though the primary candidate data server has gained the highest amount of points for the extension of the target volume, if it is determined that adding the secondary candidate data server is more appropriate in consideration of subsequent extension, the secondary candidate data server may be selected as the data server to be added, and may then be added to the target volume.

Also, although not illustrated in FIG. 1, in the method for extending a volume of a distributed file system according to an embodiment of the present invention, a sleep mode of data servers from which the distance to the extended volume is equal to or less than a preset wakeup value may be canceled, the extended volume being the target volume extended by adding a data server thereto.

In the distributed file system, once a volume has been extended, it is highly probable that the volume will be extended again. Therefore, it is necessary to prepare for the extension of the volume by frequently checking the states of data servers adjacent to the volume that is highly likely to be extended.

Accordingly, in the present invention, using the preset wakeup value, data servers located adjacent to the extended volume are selected as data servers for further extension, and the sleep modes of the selected data servers are canceled, whereby subsequent extension of the volume may be prepared for.

Through the above-described process, when further extension of the volume is required, the extension of the volume is quickly performed, whereby a storage service may be provided to clients without performance degradation.

Also, although not illustrated in FIG. 1, in the method for extending a volume of a distributed file system according to an embodiment of the present invention, various kinds of information generated during the above-described process of extending a volume may be stored.

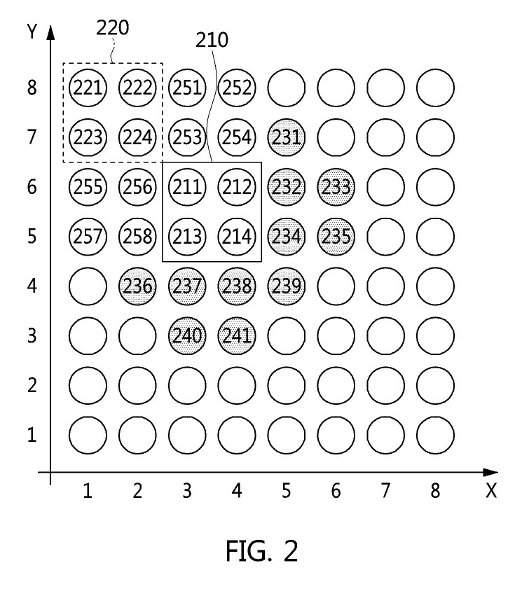

FIG. 2 is a view that schematically shows the process of extending a volume according to the method for extending a volume illustrated in FIG. 1.

Referring to FIG. 2, a torus network that can be configured in three dimensions is illustrated as being configured in two dimensions in order to easily describe the process of extending a volume according to the method for extending a volume, illustrated in FIG. 1, but the present invention may be applied to a 3-dimensional torus network.

First, the data servers illustrated in FIG. 2 may be data servers connected based on a torus network, which constitute an 8*8 matrix form.

Here, if the volume 210 is the target volume 210 to be extended, the volume 220 may be a volume neighboring the target volume 210.

If the neighboring volume 220 is expected to be extended because of frequent access thereto, the direction from the target volume 210 to the neighboring volume 220 may be excluded from the direction in which a data server is to be added to the target volume 210. That is, in FIG. 2, the leftward direction and the upward direction from the target volume 210 may be excluded from the direction in which a data server is to be added.

Here, if a preset search value is 2, data servers two or fewer hops away from the target volume 210 in the direction in which a data server is to be added may become multiple addition candidate data servers. That is, among the multiple data servers illustrated in FIG. 2, eleven data servers 231 to 241 may correspond to the addition candidate data servers.

Here, the data servers 251 to 258 are also two or fewer hops away from the target volume 210. However, because the leftward direction and the upward direction are excluded from the direction in which a data server is to be added, nine data servers, the positions of which are the coordinates <1, 5>, <1, 6>, <2, 5>, <2, 6>, <2, 7>, <3, 7>, <3, 8>, <4, 7>, and <4, 8> in FIG. 2, may not correspond to the addition candidate data servers.

Here, eleven addition candidate data servers, the positions of which are the coordinates <2, 4>, <3, 3>, <3, 4>, <4, 3>, <4, 4>, <5, 4>, <5, 5>, <5, 6>, <5, 7>, <6, 5>, and <6, 6>, may gain points based on the server state and the network communication cost thereof.

Here, the data server that has gained the highest amount of points may be selected as the data server to be added to the target volume 210, and may be added to the target volume 210.

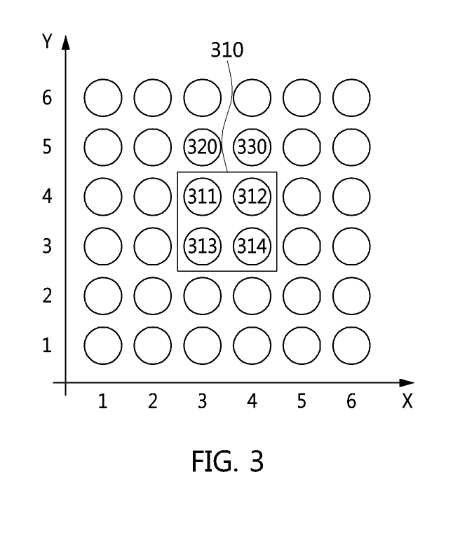

FIG. 3 is a view that schematically shows an additional allocation simulation process according to the method for extending a volume, illustrated in FIG. 1.

Referring to FIG. 3, the additional allocation simulation according to the method for extending a volume, illustrated in FIG. 1, may be performed repeatedly as many times as a simulation number preset by a system administrator.

For example, assume that the primary candidate data server 320 that has gained the highest amount of points is selected as the data server to be added to the target volume 310 to be extended, through the method for extending a volume, illustrated in FIG. 1.

Here, if the system administrator sets the value of ‘whatif’, corresponding to the simulation number, to 1, after the primary candidate data server 320 is assumed to be added to the target volume 310, a data server 330 to be additionally added to the extended server may be selected again through the method for extending a volume illustrated in FIG. 1.

Here, whether to add the primary candidate data server 320 to the target volume 310 may be finally determined in consideration of the state of the data server 330 to be additionally added and the network communication cost estimated when the data server 330 is additionally added to the extended target volume 310 in which the primary candidate data server 320 is included.

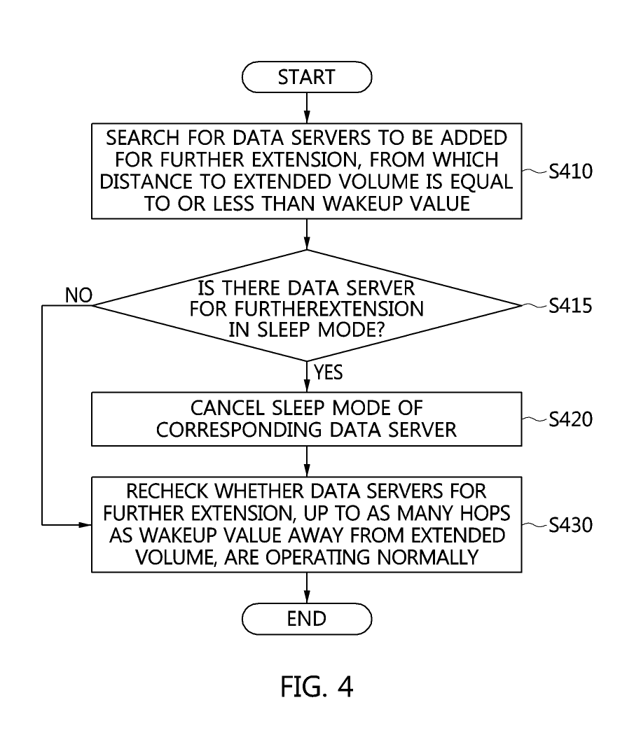

FIG. 4 is a flowchart that shows the process of cancelling a sleep mode in preparation for the subsequent extension of a volume in the method for extending a volume according to an embodiment of the present invention.

A volume that is already extended once is highly likely to be extended again. Accordingly, for the volume highly likely to be extended, the states of data servers adjacent thereto are frequently checked according to the process illustrated in FIG. 4 in order to prepare for further extension of the volume.

Referring to FIG. 4, in the process of cancelling a sleep mode in preparation for the subsequent extension of a volume in the method for extending a volume according to an embodiment of the present invention, first, data servers for further extension, from which the distance to the extended volume is equal to or less than a wakeup value, are searched for at step S410.

That is, data servers adjacent to the extended volume may be searched for.

Subsequently, whether a data server in a sleep mode is present among the data servers for further extension is determined at step S415.

Here, whether a data server in a sleep mode is present may be determined by checking the states of the multiple data servers for further extension.

Here, the sleep mode may indicate that the operation mode of a data server is set to a power-saving state in order to reduce the amount of power consumed by the system.

When it is determined at step S415 that a data server in a sleep mode is present, the sleep mode of the corresponding data server is canceled at step S420, and whether the data servers for further extension, up to as many hops as the wakeup value away from the extended volume, are operating normally is checked again at step S430.

Here, it may take a certain time to cancel the sleep mode of a data server. Therefore, the sleep modes of multiple data servers highly likely to be additionally allocated to the extended volume are cancelled in advance, whereby the time taken to cancel the sleep mode when extending the volume may be reduced.

Also, even if it is determined at step S415 that there is no data server in a sleep mode, whether the data servers for further extension, up to as many hops as the wakeup value away from the extended volume, are operating normally is checked again at step S430, whereby it is possible to prevent a problem that may be caused when the extended volume is required to be further extended.

Through this process, the further extension of the extended volume may be quickly performed, and a storage service may be provided to clients without degrading the performance of the corresponding volume.

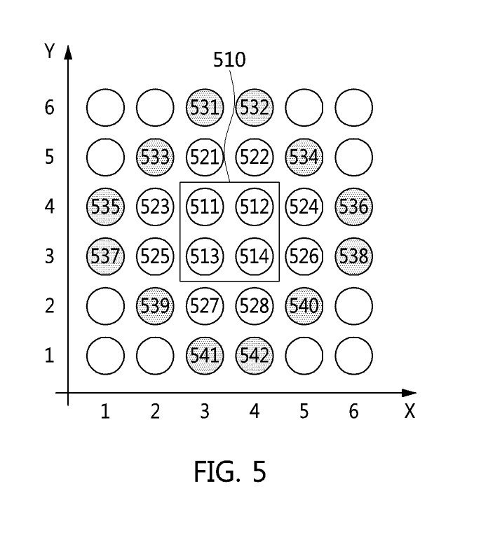

FIG. 5 is a view that schematically shows the process of cancelling a sleep-mode, illustrated in FIG. 4.

Referring to FIG. 5, in order to prepare for the subsequent extension of the extended volume according to the process of cancelling a sleep mode illustrated in FIG. 4, a wakeup value set by an administrator may be checked first.

For example, if the wakeup value preset by the system administrator is 1, data servers located one hop away from the data servers 511 to 514 included in the extended volume 510 may be searched for as data servers 521 to 528 for further extension. That is, data servers, the positions of which are the coordinates <3, 5>, <4, 5>, <2, 4>, <2, 3>, <3, 2>, <4, 2>, <5, 4>, and <5, 3> in FIG. 5, may become the data servers for further extension.

Here, the server states of the data servers 521 to 528 for further extension are checked according to the present invention, whereby whether a sleep mode is cancelled and whether the data servers for further extension are operating normally may be checked.

In another example, if the wakeup value preset by the system administrator is 2, data servers 531 to 542, two hops away from the data servers 511 to 514 included in the extended volume 510, may also be searched for, and may become the data servers for further extension. That is, data servers, the positions of which are the coordinates <1, 3>, <1, 4>, <2, 2>, <2, 5>, <3, 1>, <3, 6>, <4, 1>, <4, 6>, <5, 2>, <5, 5>, <6, 3> and <6, 4> in FIG. 5, may be added to the data servers for further extension.

Here, as the number of accesses to the extended volume 510 increases, the further extension of the extended volume may be required urgently. In this case, the wakeup value may be set large in order to prepare for multiple extensions.

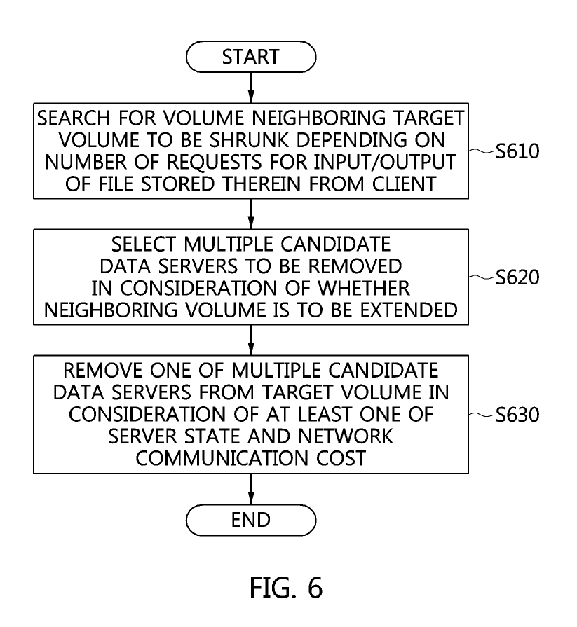

FIG. 6 is a flowchart that shows a method for shrinking a volume of a distributed file system according to an embodiment of the present invention.

Referring to FIG. 6, in the method for shrinking a volume of a distributed file system according to an embodiment of the present invention, for a target volume, the shrinkage of which is requested depending on the number of requests for input/output of files stored therein from clients, in a distributed file system, a volume neighboring the target volume is searched for at step S610.

For example, the target volume to be shrunk may be a volume that is providing a storage service using two or more data servers but is predicted to be in a state in which the number of requests for input/output of data stored therein continuously decreases with the decrease in the number of clients. Accordingly, a target volume to be shrunk may be selected based on information about whether the number of clients is decreasing or whether the number of requests for input/output of files stored in the volume is decreasing.

Here, a volume that includes a data server from which the distance to the target volume is equal to or less than a preset adjacency value may be searched for, and the found volume may be regarded as a neighboring volume. For example, based on a torus network, data servers as many hops as the adjacency value away from the target volume are searched for, and a volume that includes at least one of the found data servers may become a neighboring volume.

Here, the preset adjacency value may be set by a system administrator, and may be freely modified depending on how a system is managed.

Here, multiple neighboring volumes may be present according to the distributed file system.

Also, in the method for shrinking a volume of a distributed file system according to an embodiment of the present invention, multiple removal candidate data servers are selected at step S620 in consideration of whether a neighboring volume is to be extended.

That is, in consideration of whether a neighboring volume is expected to be extended because of frequent access thereto by clients, multiple removal candidate data servers may be selected.

Here, if a neighboring volume is expected to be extended, data servers to be allocated in the neighboring volume or data servers located in the direction toward the neighboring volume, among the multiple data servers included in the target volume, may be selected as the multiple removal candidate data servers. That is, because the neighboring volume expected to be extended may continuously add data servers thereto, if a data server located in the direction of the neighboring volume is removed from the target volume, the probability that the same data server is included both in the target volume and in the neighboring volume may decrease.

Here, if the neighboring volume is not expected to be extended, the multiple data servers included in the target volume to be shrunk may be selected as the multiple removal candidate data servers.

Also, in the method for shrinking a volume of a distributed file system according to an embodiment of the present invention, any one of the multiple removal candidate data servers is removed from the target volume at step S630 in consideration of at least one of a server state of each of the multiple removal candidate data servers and a resulting network communication cost estimated when each of the multiple removal candidate data servers is removed from the target volume.

That is, among the multiple removal candidate data servers, the data server that is most suitable in consideration of the server state and the network communication cost may be selected as the data server to be removed from the target volume.

Here, the server state may include at least one of CPU utilization, memory utilization, and network utilization.

Also, the network communication cost may be the cost of communication between data servers, which increases with the number of hops therebetween based on a torus network corresponding to the distributed file system.

Here, in the distributed file system, the network communication cost is very important because data servers continuously send and receive data therebetween in order to realize fault tolerance.

Here, points based on the server state and the network communication cost may be given to each of the multiple removal candidate data servers.

Here, as at least one of the CPU utilization and the network utilization is higher, more points may be given. Also, as at least one of the memory utilization and the network communication cost is lower, more points may be given.

Here, if the data server having the higher CPU utilization and the higher network utilization is removed from the target volume, the CPU utilization and network utilization of the target volume may be reduced.

Also, if a data server that stores a lot of data therein is removed from a volume, the data stored in the corresponding data server must be moved to another data server remaining in the volume, which may generate a load. Therefore, as the memory utilization of a data server is lower, more points may be given.

Here, among the multiple removal candidate data servers, the data server that has gained the highest amount of points may be selected as the data server to be removed.

Also, although not illustrated in FIG. 6, in the method for shrinking a volume of a distributed file system according to an embodiment of the present invention, for the target volume to be shrunk, whether a neighboring volume expected to be shrunk is present is checked.

Here, if a neighboring volume expected to be shrunk is present, a data server from which the distance to the neighboring volume is equal to or less than a preset reference value, among the multiple data servers included in the target volume to be shrunk, may be excluded from the multiple removal candidate data servers. That is, if the neighboring volume is also shrunk, the probability that the target volume and the neighboring volume will overlap by including the same data server may decrease. Therefore, rather than removing the data server located in the direction toward the neighboring volume expected to be shrunk, a data server in another direction is removed from the target volume, whereby the probability that the target volume and another volume will overlap may decrease.

Also, although not illustrated in FIG. 6, in the method for shrinking a volume of a distributed file system according to an embodiment of the present invention, multiple sleep-mode target data servers, from which the distance to the shrunk volume is equal to a preset sleep value, may be set to enter a sleep mode, the shrunk volume being the target volume shrunk by removing a data server therefrom.

Here, the system administrator may set as many data servers as possible to enter a sleep mode in order to reduce the amount of power consumed by the entire distributed file system. However, if a data server is set to enter a sleep mode simply because it is rarely accessed by clients, the corresponding data server may be used in the near future. In this case, the sleep mode of the data server must be cancelled before use, which may result in a serious performance degradation. Therefore, it is necessary to select a data server to which access will not be attempted in the near future and to set the selected data server to enter a sleep mode in order to reduce the amount of power consumed by the entire system without performance degradation.

Accordingly, the present invention sets data servers from which the distance to the shrunk volume is equal to the sleep value to enter a sleep mode, thereby reducing power consumption while preventing system performance from being degraded.

Here, if it is necessary to cancel the sleep modes of the multiple sleep-mode target data servers due to the effect of another volume, the sleep modes may be cancelled. For example, any one of the sleep-mode target data servers may correspond to a sleep-mode target data server for the shrunk volume as well as a data server to be additionally allocated to an extended volume. In this case, because the corresponding data server may be used, the sleep mode thereof may be cancelled even though it is a sleep-mode target data server.

Also, a data server may be set to enter a sleep mode after the lapse of a sleep-mode waiting time, set by the system administrator, since storage devices, such as an SSD, a HDD, and the like, were changed to enter a sleep mode, whereby it is possible to rapidly respond to a situation in which the cancellation of a sleep mode is required.

Here, whether the shrunk volume is to be further shrunk may be predicted.

That is, if the number of accesses to the shrunk volume continuously decreases or if there is no access thereto for a certain period, the volume may be further shrunk.

Here, if the shrunk volume is expected to be further shrunk, more data servers may be set to enter a sleep mode by decreasing the sleep value. That is, data servers located closer to the shrunk volume are searched for as sleep-mode target data servers, and the found data servers are set to enter a sleep mode, whereby the amount of power consumed by the distributed file system may be further reduced.

Also, although not illustrated in FIG. 6, in the method for shrinking a volume of a distributed file system according to an embodiment of the present invention, various kinds of information generated during the above-described process of shrinking a volume may be stored.

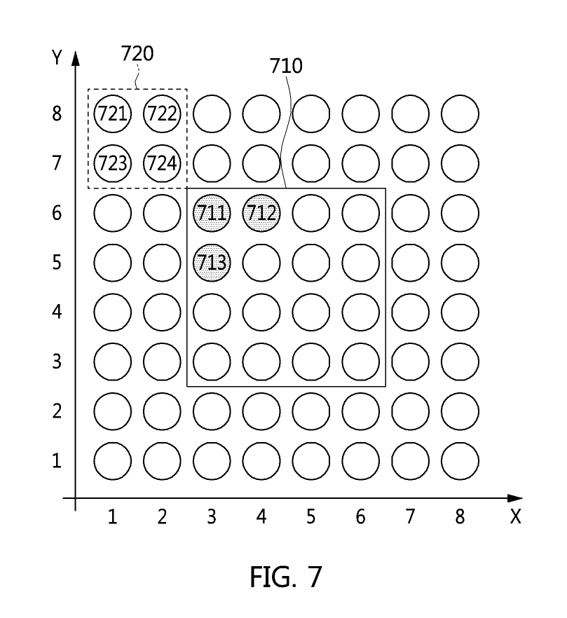

FIG. 7 is a view that schematically shows the process of shrinking a volume according to the method for shrinking a volume, illustrated in FIG. 6.

Referring to FIG. 7, a torus network that can be configured in three dimensions is illustrated as being configured in two dimensions in order to easily describe the process of shrinking a volume according to the method for shrinking a volume, illustrated in FIG. 6, but the present invention may be applied to a 3-dimensional torus network.

First, the data servers illustrated in FIG. 7 may be data servers connected based on a torus network, which constitute an 8*8 matrix form.

Here, if the volume 710 is the target volume 710 to be shrunk, the volume 720 may be a volume neighboring the target volume 710.

If the neighboring volume 720 is expected to be extended because of frequent access thereto, data servers 711 to 713 located in the direction toward the neighboring volume 720, among the data servers included in the target volume 710, may become removal candidate data servers.

That is, if the neighboring volume 720 is extended, because a data server included in the target volume 710 may be allocated to the neighboring volume 720 in the future, a data server to be removed from the target volume 710 may be selected from among data servers located in the direction toward the neighboring volume 720 that is expected to be extended, in order to decrease the probability that a data server is included both in the target volume 710 and in the neighboring volume 720.

Subsequently, in consideration of information about the state of the removal candidate data servers 711 to 713 and the resulting network communication cost estimated when each of the removal candidate data servers 711 to 713 is removed from the target volume 710, any one of the removal candidate data servers 711 to 713 may be removed from the target volume 710.

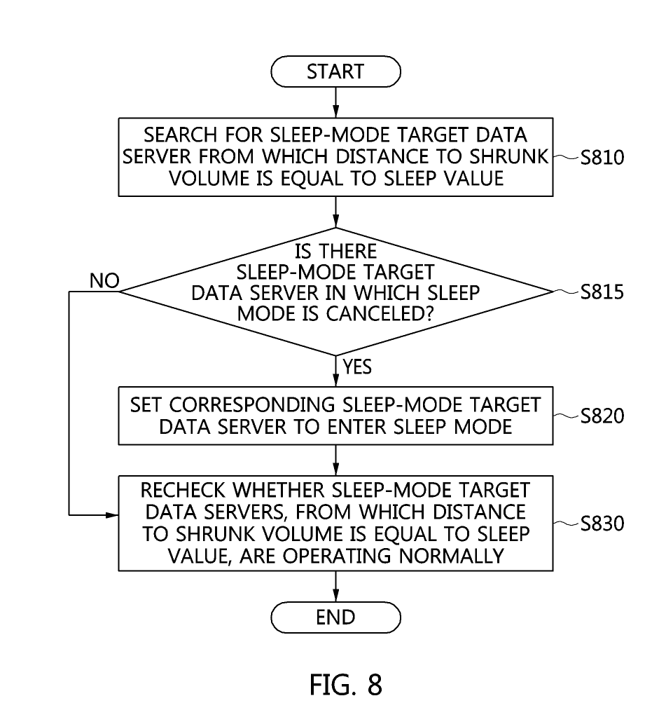

FIG. 8 is a flowchart that shows the process of performing a power-saving function after a volume is shrunk in a method for shrinking a volume according to an embodiment of the present invention.

Referring to FIG. 8, in the process of performing a power-saving function after a volume is shrunk in the method for shrinking a volume according to an embodiment of the present invention, first, sleep-mode target data servers, from which the distance to the shrunk volume is equal to a sleep value, are searched for at step S810.

That is, data servers adjacent to the shrunk volume may be searched for.

Then, whether there is a sleep-mode target data server in which a sleep mode is cancelled is determined at step S815.

Here, whether there is a sleep-mode target data server in which a sleep mode is cancelled may be determined by checking the server states of the multiple sleep-mode target data servers.

When it is determined at step S815 that there is a sleep-mode target data server in which a sleep mode is cancelled, the corresponding sleep-mode target data server is set to enter a sleep mode at step S820, and whether the sleep-mode target data servers, from which the distance to the shrunk volume is equal to the sleep value, are operating normally is checked again at step S830.

Here, if the corresponding sleep-mode target data server is adjacent to another volume, other than the shrunk volume, the corresponding sleep-mode target data server may be set to enter a sleep mode after checking the sleep value of the other volume.

Here, a system administrator must set as many data servers as possible to enter a sleep mode in order to reduce the amount of power consumed by the entire system, but if a rarely accessed data server is set to enter a sleep mode, the cancellation of the sleep mode may be frequently required, which may degrade system performance.

Therefore, the present invention sets data servers that are adjacent to a volume predicted not to be accessed by clients, such as a shrunk volume, to enter a sleep mode, thereby reducing power consumption while preventing system performance from being degraded.

Also, even if it is determined at step S815 that there is no sleep-mode target data server in which the sleep mode is cancelled, whether the sleep-mode target data servers, from which the distance to the shrunk volume is equal to the sleep value, are operating normally is checked again at step S830, whereby a problem may be prevented from occurring in the operation of the entire distributed file system.

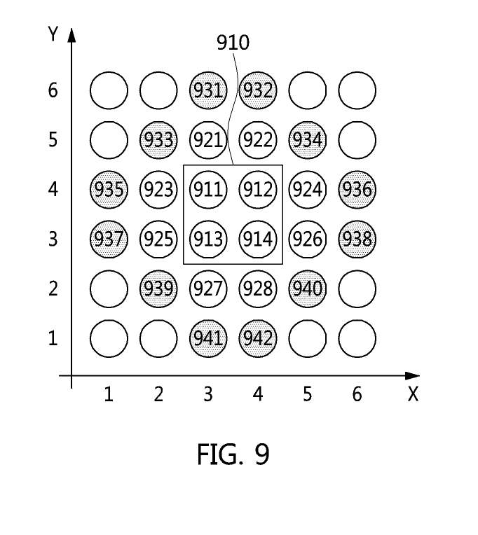

FIG. 9 is a view that schematically shows the process of performing the power-saving function illustrated in FIG. 8.

Referring to FIG. 9, in order to reduce the amount of power consumed by a system according to the process of performing the power-saving function illustrated in FIG. 8, a sleep value preset by an administrator may be checked first.

For example, if the sleep value preset by the system administrator is 2, data servers two hops away from the data servers 911 to 914 included in the shrunk volume 910 are searched for as sleep-mode target data servers 931 to 942. That is, twelve data servers, the positions of which are the coordinates <1, 3>, <1, 4>, <2, 2>, <2, 5>, <3, 1>, <3, 6>, <4, 1>, <4, 6>, <5, 2>, <5, 5>, <6, 3>, and <6, 4> in FIG. 9, may become sleep-mode target data servers.

Here, the server states of the sleep-mode target data servers 931 to 942 are checked according to the present invention, whereby whether a sleep mode is set therein and whether they are operating normally may be checked.

If the shrunk volume 910 is expected to be further shrunk because it is rarely accessed or is not accessed, the system administrator may add data servers that are closer to the shrunk volume to the sleep-mode target data servers by setting the sleep value to 1. That is, eight data servers, the positions of which are the coordinates <3, 5>, <4, 5>, <2, 4>, <2, 3>, <3, 2>, <4, 2>, <5, 4>, and <5, 3> in FIG. 9, are added to the sleep-mode target data servers, whereby the amount of power consumed by the system may be further reduced.

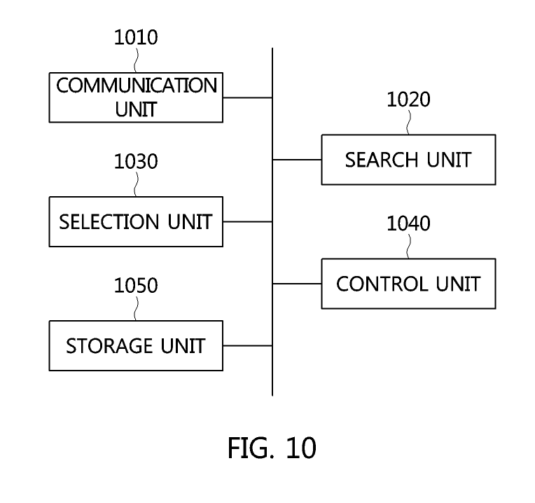

FIG. 10 is a block diagram that shows an apparatus for resizing a volume of a distributed file system according to an embodiment of the present invention.

Referring to FIG. 10, an apparatus for resizing a volume of a distributed file system according to an embodiment of the present invention includes a communication unit 1010, a search unit 1020, a selection unit 1030, a control unit 1040, and a storage unit 1050.

The communication unit 1010 may send and receive data necessary for resizing a volume of a distributed file system via a communication network, such as a torus network or the like. Particularly, the communication unit 1010 according to an embodiment of the present invention may receive a request to extend or shrink a volume, information about the states of data servers, and the like.

The search unit 1020 searches for a first neighboring volume that is adjacent to an extension target volume, the extension of which is requested depending on the number of requests for input/output of files stored therein from clients, in a distributed file system.

For example, the extension target volume may be a volume that has provided a storage service using one or more data servers since the outset but is predicted to be in a state in which the number of requests for input/output of data stored therein rapidly increases with the increase in the number of clients. Therefore, the extension target volume may be selected based on information about whether the number of clients is increasing or whether the number of requests for input/output of files stored in the volume is increasing.

Here, a volume that includes a data server from which the distance to the extension target volume is equal to or less than a preset first adjacency value may be searched for, and the found volume may be regarded as the first neighboring volume. For example, based on a torus network, data servers as many hops as the first adjacency value away from the extension target volume are searched for, and a volume including at least one of the found data servers may become the first neighboring volume.

Here, the first adjacency value may be preset by a system administrator, and may be freely modified depending on how a system is managed.

Here, a plurality of first neighboring volumes may be present according to the distributed file system.

Also, the search unit 1020 searches for a second neighboring volume that is adjacent to a shrinkage target volume, the shrinkage of which is requested depending on the number of requests for input/output of files stored therein from clients, in the distributed file system.

For example, the shrinkage target volume may be a volume that is providing a storage service using two or more data servers but is predicted to be in a state in which the number of requests for input/output of data stored therein continuously decreases with the decrease in the number of clients. Therefore, the shrinkage target volume may be selected based on information about whether the number of clients is decreasing or whether the number of requests for input/output of files stored in the volume is decreasing.

Here, a volume that includes a data server, from which the distance to the shrinkage target volume is equal to or less than a preset second adjacency value, may be searched for, and the found volume may be regarded as the second neighboring volume. For example, based on a torus network, data servers as many hops as the second adjacency value away from the shrinkage target volume are searched for, and a volume including at least one of the found data servers may become the second neighboring volume.

Here, the second adjacency value may be preset by the system administrator, and may be freely modified depending on how a system is managed.

Here, a plurality of second neighboring volumes may be present according to the distributed file system.

The selection unit 1030 selects multiple addition candidate data servers, from which the distance to the extension target volume is equal to or less than a preset search value in a direction in which a data server is to be added, in consideration of whether the first neighboring volume is to be extended.

For example, if the preset search value is 2, multiple data servers two or fewer hops away from the extension target volume are searched for, and the found data servers may be regarded as multiple addition candidate data servers. Here, if there is a direction excluded from the direction in which a data server is to be added, data servers located in the corresponding direction may not be searched for.

Here, the preset search value may be set by the system administrator.

Here, the direction in which a data server is to be added to the extension target volume may be determined in consideration of whether the first neighboring volume is to be extended.

That is, the direction in which a data server is to be added may be determined in consideration of whether the first neighboring volume is expected to be extended because of frequent access thereto by clients.

Here, if the first neighboring volume is expected to be extended, the direction from the extension target volume to the first neighboring volume may be excluded from the direction in which a data server is to be added.

For example, assume that the first neighboring volume expected to be extended is located above the extension target volume in the direction of the y-axis in a 2-dimensional coordinate system. Here, the upward direction from the position of the extension target volume may be excluded from the direction in which a data server is to be added.

Here, the first neighboring volume expected to be extended tends to be continuously extended. Accordingly, if the extension target volume adds a data server thereto in the direction toward the position of the first neighboring volume, it is probable that the extension target volume and the first neighboring volume will overlap by adding the same data server. In order to decrease the probability of such overlap, the direction toward the position of the first neighboring volume expected to be extended is not set as the direction in which a data server is to be added, whereby a data server is prevented from being added in the direction toward the position of the first neighboring volume that is expected to be extended.

Also, the selection unit 1030 selects multiple removal candidate data servers in the shrinkage target volume in consideration of whether the second neighboring volume is to be extended.

That is, the multiple removal candidate data servers may be selected in consideration of whether the second neighboring volume is expected to be extended because of frequent access thereto by clients.

Here, if the second neighboring volume is expected to be extended, data servers to be allocated to the second neighboring volume or data servers located in the direction toward the second neighboring volume, among the multiple data servers included in the shrinkage target volume, may be selected as the multiple removal candidate data servers. That is, because the second neighboring volume expected to be extended may continuously add data servers thereto for extension, if a data server located in the direction toward the second neighboring volume is removed from the shrinkage target volume, the probability that the same data server is included both in the shrinkage target volume and in the second neighboring volume may decrease.

Here, if the second neighboring volume is not expected to be extended, the multiple data servers included in the shrinkage target volume may be selected as the multiple removal candidate data servers.

The control unit 1040 adds any one of the multiple addition candidate data servers to the extension target volume in consideration of at least one of the server state of each of the multiple addition candidate data servers and the resulting network communication cost estimated when each of the multiple addition candidate data servers is added to the extension target volume.

That is, among the multiple addition candidate data servers, the data server that is most suitable in consideration of the server states and the network communication cost may be selected as the data server to be added to the extension target server.

Here, the server state may include at least one of CPU utilization, memory utilization, and network utilization, and the network communication cost may be the cost of communication between data servers, which increases with the number of hops therebetween based on a torus network, corresponding to the distributed file system.

Here, in the distributed file system, the network communication cost is very important because data servers continuously send and receive data therebetween in order to realize fault tolerance.

Here, among the multiple addition candidate data servers, any one primary candidate data server that has gained the highest amount of points based on the server state and the network communication cost may be selected.

Here, as the CPU utilization, the memory utilization, the network utilization, and the network communication are lower, more points may be given. That is, a data server of which the CPU utilization, the memory utilization, the network utilization, and the network communication cost are lower may be more advantageously added for extension.

Here, among the multiple addition candidate data servers, whether at least one secondary candidate data server that has gained points equal to or greater than a preset number of reference points is present may be determined.

Here, the preset number of reference points may be a certain percentage of the full points given based on the server state and the network communication cost, or may be a certain percentage of the points of the primary candidate data server.

Here, if at least one secondary candidate data server is present, an additional allocation simulation is performed for each of the primary candidate data server and the at least one secondary candidate data server, and any one of the primary candidate data server and the at least one secondary candidate data server may be selected as the data server to be added depending on the result of the additional allocation simulation.

Here, the data server to be added may be selected in consideration of data servers expected to be additionally added by each of the primary candidate data server and the at least one secondary candidate data server when the additional allocation simulation is performed.

Specifically, the additional allocation simulation is configured to generate a virtual extended volume by adding any one of the primary candidate data server and the at least one secondary candidate data server to the extension target volume and to search for data servers expected to be additionally added when performing extension after recognizing the virtual extended server as the extension target volume.

That is, the additional allocation simulation may be a means for checking the states and network costs of data servers expected to be additionally allocated to the extension target volume when repeatedly performing the process of extending the extension target volume according to the present invention.

Here, the additional allocation simulation may be performed repeatedly as many times as a preset simulation number. For example, when the system administrator sets the value of ‘whatif’, corresponding to the preset simulation number, to 2, the additional allocation simulation may be performed twice for each of the primary candidate data server and the at least one secondary candidate data server.

By performing the additional allocation simulation as described above, whether the primary candidate data server that has gained the highest amount of points is most suitable as the data server to be added for the extension of the extension target volume may be verified.

That is, if there is a secondary candidate data server that has gained a relatively high amount of points, other than the primary candidate data server, the additional allocation simulation is also performed for the secondary candidate data server, and then the result may be compared with the result of the simulation performed for the primary candidate data server. Even if the primary candidate data server has gained the highest amount of points for the extension of the extension target volume, if it is determined that adding the secondary candidate data server is more appropriate in consideration of the subsequent extension, the secondary candidate data server may be selected as the data server to be added, and may then be added to the extension target volume.

Also, a sleep mode of data servers from which the distance to the extended volume is equal to or less than a preset wakeup value may be canceled, the extended volume being the extension target volume, extended by adding a data server thereto.

In the distributed file system, once a volume has been extended, it is highly likely to be extended again. Therefore, it is necessary to prepare for the extension of the volume by frequently checking the states of data servers adjacent to the volume that is highly likely to be extended.

Accordingly, in the present invention, using the preset wakeup value, data servers located adjacent to the extended volume are selected as data servers for further extension, and the sleep modes of the selected data servers are canceled, whereby the subsequent extension of the volume may be prepared for.

Through the above-described process, when the further extension of the volume is required, the extension of the volume is quickly performed, whereby a storage service may be provided to clients without performance degradation.

Also, the control unit 104 removes any one of the multiple removal candidate servers from the shrinkage target volume in consideration of at least one of the server state of each of the multiple removal candidate data servers and the resulting network communication cost estimated when each of the multiple removal candidate data servers is removed from the shrinkage target volume.

That is, among the multiple candidate data servers, the data server that is most suitable in consideration of the server state and the network communication cost may be selected as the data server to be removed from the shrinkage target volume.

Here, the server state may include at least one of CPU utilization, memory utilization, and network utilization.

Also, the network communication cost may be the cost of communication between data servers, which increases with the number of hops therebetween based on a torus network corresponding to the distributed file system.

Here, in the distributed file system, the network communication cost is very important because data servers continuously send and receive data therebetween in order to realize fault tolerance.

Here, points based on the server state and the network communication cost may be given to each of the multiple removal candidate data servers.

Here, as at least one of the CPU utilization and the network utilization is higher, more points may be given. Also, as at least one of the memory utilization and the network communication cost is lower, more points may be given.

Here, if the data server having the higher CPU utilization and the higher network utilization is removed from the shrinkage target volume, the CPU utilization and network utilization of the shrinkage target volume may be reduced.

Also, if a data server that stores a lot of data therein is removed from a volume, the data stored in the corresponding data server must be moved to another data server remaining in the volume, which may generate a load. Therefore, as the memory utilization of a data server decreases, more points may be given.

Here, among the multiple removal candidate data servers, the data server that has gained the highest amount of points may be selected as the data server to be removed.

Also, for the shrinkage target volume, whether a neighboring volume expected to be shrunk is present is determined.

Here, if a neighboring volume expected to be shrunk is present, a data server from which the distance to the neighboring volume is equal to or less than a preset reference value, among the multiple data servers included in the shrinkage target volume, may be excluded from the multiple removal candidate data servers. That is, if the neighboring volume is also shrunk, the probability that the shrinkage target volume and the neighboring volume will overlap by including the same data server may decrease. Therefore, rather than removing a data server located in the direction of the neighboring volume expected to be shrunk, a data server in another direction is removed from the shrinkage target volume, whereby the probability that the shrinkage target volume and another volume will overlap may decrease.

Also, multiple sleep-mode target data servers, from which the distance to the shrunk volume is equal to a preset sleep value, may be set to enter a sleep mode, the shrunk volume being the shrinkage target volume shrunk by removing a data server therefrom.

Here, the system administrator may set as many data servers as possible to enter a sleep mode in order to reduce the amount of power consumed by the entire distributed file system. However, if a data server is set to enter a sleep mode simply because it is rarely accessed by clients, the corresponding data server may be used in the near future. In this case, the sleep mode of the data server must be cancelled before use, which may result in a serious performance degradation. Therefore, it is necessary to select a data server to which access will not be attempted in the near future and to set the selected data server to enter a sleep mode in order to reduce the amount of power consumed by the entire system without performance degradation.

Accordingly, the present invention sets data servers from which the distance to the shrunk volume is equal to the sleep value to enter a sleep mode, thereby reducing power consumption while preventing system performance from being degraded.

Here, if it is necessary to cancel the sleep modes of the multiple sleep-mode target data servers due to the effect of another volume, the sleep modes may be cancelled. For example, any one of the sleep-mode target data servers may correspond to a sleep-mode target data server for the shrunk volume as well as a data server to be additionally allocated to an extended volume. In this case, because the corresponding data server may be used, the sleep mode thereof may be cancelled even though it is a sleep-mode target data server.

Also, a data server may be set to enter a sleep mode when a sleep-mode waiting time, set by the system administrator, elapses after storage devices, such as an SSD, a HDD, and the like, are changed to enter a sleep mode, whereby it is possible to rapidly respond to a situation in which the cancellation of a sleep mode is required.

Here, whether the shrunk volume is to be further shrunk may be predicted.

That is, if the number of accesses to the shrunk volume continuously decreases or if there is no access thereto for a certain period, the volume may be further shrunk.

Here, if the shrunk volume is expected to be further shrunk, more data servers may be set to enter a sleep mode by decreasing the sleep value. That is, data servers located closer to the shrunk volume are searched for as sleep-mode target data servers, and the found data servers are set to enter a sleep mode, whereby the amount of power consumed by the distributed file system may be further reduced.

The storage unit 1050 stores various kinds of information generated during the above-described process of resizing a volume according to an embodiment of the present invention.

According to an embodiment, the storage unit 1050, configured to be separate from the apparatus for resizing a volume, may support the function of resizing a volume. Here, the storage unit 1050 may operate as separate mass storage, and may include a control function for performing operations.

Meanwhile, because the apparatus for resizing a volume contains memory therein, it may store information. In an embodiment, the memory is a computer-readable recording medium. In an embodiment, the memory may be a volatile memory unit, and in another embodiment, the memory may be a nonvolatile memory unit. In an embodiment, the storage is a computer-readable recording medium. In different embodiments, the storage may include, for example, a hard disk, an optical disk, or another kind of mass storage device.

Here, the apparatus for resizing a volume of a distributed file system according to the present invention may operate by being connected with data servers via a switch or by being located in a torus network.

Using the above-described apparatus for resizing a volume of a distributed file system, the extension and shrinkage of a volume may be effectively provided in a torus-network-based distributed file system for the construction of cloud storage having capacity on the order of exabytes.

Also, when a data server is added to or removed from a volume, the cost of network communication between data servers allocated in the volume may be minimized.

Also, because a volume is extended or shrunk in the direction determined in consideration of the state of a neighboring volume, performance degradation attributable to the overlap of volumes may be prevented.

Also, when a volume is extended or shrunk, the sleep modes of data servers adjacent to the volume are appropriately changed, whereby the total amount of power consumed by the large-scale distributed file system may be reduced.

According to the present invention, in order to construct large-scale storage, a method for effectively extending and shrinking a volume in a distributed file system based on a torus network may be provided.

Also, the present invention may provide technology for resizing a volume, which may minimize the cost of network communication between data servers allocated to a volume in consideration of the characteristics of a torus network.

Also, the present invention may prevent performance degradation that may arise from the overlap of volumes when resizing volumes of a distributed file system.

Also, the present invention may provide technology for reducing the amount of power consumed by the entire system when resizing a volume of a distributed file system.

As described above, the method for extending and shrinking a volume of a distributed file system based on a torus network and the apparatus for the same according to the present invention are not limitedly applied to the configurations and operations of the above-described embodiments, but all or some of the embodiments may be selectively combined and configured, so that the embodiments may be modified in various ways.

What is claimed is:

1. A method for extending a volume of a distributed file system, comprising:
searching for a neighboring volume of an extension target volume, extension of which is requested depending on a number of requests for input/output of files stored therein from clients, in a distributed file system;
determining a direction in which a data server is to be added to the extension target volume in consideration of whether the neighboring volume is to be extended;
searching for multiple addition candidate data servers, from which a distance to the extension target volume is equal to or less than a preset search value in the direction in which a data server is to be added; and
adding a data server to the extension target volume, the data server being selected from among the multiple addition candidate data servers in consideration of at least one of a server state of each of the multiple addition candidate data servers and a resulting network communication cost estimated when each of the multiple addition candidate data servers is added to the extension target volume.

2. The method of claim 1, wherein adding the data server comprises:
selecting a single primary candidate data server that has gained a highest amount of points based on the server state and the resulting network communication cost from among the multiple addition candidate data servers;
determining whether at least one secondary candidate data server, points of which are equal to or greater than a preset number of reference points, is present among the multiple addition candidate data servers; and
when it is determined that the at least one secondary candidate data server is present, performing an additional allocation simulation for each of the primary candidate data server and the at least one secondary candidate data server, and selecting any one of the primary candidate data server and the at least one secondary candidate data server as the data server to be added depending on a result of the additional allocation simulation.

3. The method of claim 2, wherein selecting any one of the primary candidate data server and the at least one secondary candidate data server is configured to select the data server to be added in consideration of a data server to be additionally added by each of the primary candidate data server and the at least one secondary candidate data server when the additional allocation simulation is performed.

4. The method of claim 3, wherein the additional allocation simulation is configured to generate a virtual extended volume by adding any one of the primary candidate data server and the at least one secondary candidate data server to the extension target volume and to search for the data server to be additionally added by performing extension after recognizing the virtual extended volume as the extension target volume.

5. The method of claim 2, wherein the server state includes at least one of CPU utilization, memory utilization, and network utilization, and the resulting network communication cost is a cost of communication between data servers, which increases with a number of hops based on a torus network corresponding to the distributed file system.

6. The method of claim 5, wherein selecting the single primary candidate data server is configured to give more points as at least one of the CPU utilization, the memory utilization, the network utilization, and the resulting network communication cost is lower.

7. The method of claim 2, wherein selecting any one of the primary candidate data server and the at least one secondary candidate data server is configured to perform the additional allocation simulation repeatedly as many times as a preset simulation number.

8. The method of claim 1, further comprising:
cancelling sleep modes of multiple data servers for further extension, from which a distance to an extended volume is equal to or less than a preset wakeup value, the extended volume being the extension target volume, extended by adding the data server thereto.

9. The method of claim 1, wherein determining the direction in which a data server is to be added is configured such that a direction from the extension target volume to the neighboring volume is excluded from the direction in which a data server is to be added when the neighboring volume is expected to be extended.

10. The method of claim 1, wherein searching for the neighboring volume is configured to search for a volume that includes a data server from which a distance to the extension target volume is equal to or less than a preset adjacency value as the neighboring volume.

11. A method for shrinking a volume of a distributed file system, comprising:
searching for a neighboring volume of a shrinkage target volume, shrinkage of which is requested depending on a number of requests for input/output of files stored therein from clients, in a distributed file system;
selecting multiple removal candidate data servers in the shrinkage target volume in consideration of whether the neighboring volume is to be extended; and
removing a data server from the shrinkage target volume, the data server being selected from among the multiple removal candidate data servers in consideration of at least one of a server state of each of the multiple removal candidate data servers and a resulting network communication cost estimated when each of the multiple removal candidate data servers is removed from the shrinkage target volume.

12. The method of claim 11, wherein removing the data server comprises:
giving points to each of the multiple removal candidate data servers based on the server state and the resulting network communication cost; and
among the multiple removal candidate data servers, selecting a data server that has gained a highest amount of points as the data server to be removed.

13. The method of claim 12, wherein the server state includes at least one of CPU utilization, memory utilization, and network utilization, and the resulting network communication cost is a cost of communication between data servers, which increases with a number of hops based on a torus network corresponding to the distributed file system.

14. The method of claim 13, wherein giving the points is configured to give more points as at least one of the CPU utilization and the network utilization is higher, and to give more points as at least one of the memory utilization and the resulting network communication cost is lower.

15. The method of claim 11, further comprising:
determining whether a neighboring volume expected to be shrunk is present, the neighboring volume being adjacent to the shrinking target volume; and
when it is determined that the neighboring volume expected to be shrunk is present, excluding a data server from which a distance to the neighboring volume expected to be shrunk is equal to or less than a preset reference value, among multiple data servers included in the shrinkage target volume, from the multiple removal candidate data servers.

16. The method of claim 11, further comprising:
setting multiple sleep-mode target data servers, from which a distance to a shrunk volume is equal to a preset sleep value, to enter a sleep mode, the shrunk volume being the shrinkage target volume, shrunk by removing the data server therefrom.

17. The method of claim 16, wherein setting the multiple sleep-mode target data servers to enter a sleep mode comprises:
predicting whether the shrunk volume is to be further shrunk; and
when the shrunk volume is predicted to be further shrunk, setting more data servers to enter a sleep mode by decreasing the sleep value.

18. The method of claim 11, wherein selecting the multiple removal candidate data servers is configured to:
among multiple data servers included in the shrinkage target volume, select a data server capable of being included in the neighboring volume or a data server located in a direction toward the neighboring volume as the multiple removal candidate data servers when the neighboring volume is expected to be extended; and
select the multiple data servers included in the shrinkage target volume as the multiple removal candidate data servers when the neighboring volume is not expected to be extended.

19. The method of claim 11, wherein searching for the neighboring volume is configured to search for a volume that includes a data server from which a distance to the shrinkage target volume is equal to or less than a preset adjacency value as the neighboring volume.

20. An apparatus for resizing a volume of a distributed file system, comprising:
a search unit for searching for a first neighboring volume that is adjacent to an extension target volume, extension of which is requested, and searching for a second neighboring volume that is adjacent to a shrinkage target volume, shrinkage of which is requested, in a distributed file system, the extension and the shrinkage being requested depending on a number of requests for input/output of files stored in the volume from clients;
a selection unit for selecting multiple addition candidate data servers, from which a distance to the extension target volume is equal to or less than a preset search value in a direction in which a data server is to be added, in consideration of whether the first neighboring volume is to be extended, and selecting multiple removal candidate data servers in the shrinkage target volume in consideration of whether the second neighboring volume is to be extended; and
a control unit for adding any one of the multiple addition candidate data servers to the extension target volume in consideration of at least one of a server state of each of the multiple addition candidate data servers and a resulting network communicate cost estimated when each of the multiple addition candidate data servers is added to the extension target volume, and removing any one of the multiple removal candidate data servers from the shrinkage target volume in consideration of at least one of a server state of each of the multiple removal candidate data servers and a resulting network communication cost estimated when each of the multiple removal candidate data servers is removed from the shrinkage target volume.
